(19) United States
(12) Patent Application Publication
(10) Pub. No.: US 2025/0058455 A1
(43) Pub. Date: Feb. 20, 2025

(54) Packaging Device for an Accessory Device

(71) Applicant: Robert Bosch GmbH, Stuttgart (DE)

(72) Inventors: Frederick Clifford Paddock, Jamestown, NC (US); Pascal Maeder, Bern (CH); Aleksei Aleksandrovich Ruin, Solothurn (CH); Mark Shickle, London (GB); Warren Keefe, London (GB); Benedek Peter Doemeny, Zürich (CH); Patrick Wessner, Aarau Rohr (CH)

(21) Appl. No.: 18/722,853

(22) PCT Filed: Dec. 14, 2022
(86) PCT No.: PCT/EP2022/085741

§ 371 Date: Jun. 21, 2024

(30) Foreign Application Priority Data
Dec. 18, 2021 (DE) 10 2021 215 064.0

(51) Int. Cl. B25H 3/00; B25H 3/02

(52) U.S. Cl. CPC B25H 3/003; B25H 3/022

(57) ABSTRACT

A packaging device for an accessory device includes a retaining element for retaining the accessory device, a clamping element for clamping the accessory device, and a clamping recess for receiving the accessory device. The clamping element, in particular the clamping recess, is provided for clamping the accessory device depending on a movement, in particular a rotational movement, of the clamping element relative to the accessory device, in particular a longitudinal axis of the accessory device.

The invention relates to a packaging device according to the preamble of claim 1.

### PRIOR ART

In DE 20 2011 105 720 U1, a packaging container for elongate objects, in particular small, high-quality precision tools, having a base body with a longitudinal receiving and removal opening, which can be closed repeatedly by means of a protective element, wherein the base body has a base part to which a gripping part with at least one elastically deformable U-shaped gripping jaw is attached for gripping the object in a force-fitting, and optionally form-fitting, manner, a protective part being attached in turn to this gripping jaw, wherein the gripping force of the gripping jaw is increased or decreased in an incremental manner when the object is received and removed, wherein the base part is divided at least into an upper part and a lower part, wherein the lower part is rigidly connected to the gripping part, and wherein the upper part is fastened or fastenable to the lower part in such a way that the space for receiving the free end of the tool shaft can be accessed freely by a user's finger when the upper part is in at least one open position, but is blocked when the upper part is in the closed position.

### DISCLOSURE OF THE INVENTION

The object of the invention is to improve a packaging device for an accessory device by means of simple design measures.

The object is achieved by a packaging device for an accessory device having a clamping element for clamping the accessory device and having a clamping recess for receiving the accessory device.

It is proposed that the clamping element, in particular the clamping recess, is provided for clamping the accessory device depending on a movement, in particular a rotational and/or translational movement, of the clamping element about the accessory device, in particular about a longitudinal axis of the accessory device.

The present packaging device makes it possible for an operator to accommodate an accessory device particularly securely and reliably in a packaging device in a particularly simple manner. The clamping element can be unclamped or opened in a particularly simple manner to allow the accessory device to be introduced. The clamping element can be clamped or closed in a particularly simple manner to allow the accessory device to be retained in the packaging device.

This makes it possible to reduce injuries sustained when introducing or inserting and/or removing or withdrawing the accessory device into/from the packaging device.

The clamping element, in particular the clamping recess, may clamp the accessory device by means of a movement, in particular a rotational movement, of the clamping element, in particular the clamping recess, in the circumferential direction around the accessory device, in particular around a longitudinal axis of the accessory device, and/or may unclamp the accessory device by means of a corresponding opposite movement counter to the circumferential direction.

The clamping element, in particular the clamping recess, may be provided to widen in order to receive the accessory device, and to narrow in order to clamp the accessory device.

The clamping element may be provided for clamping the accessory device by means of a lateral surface, in particular an inner lateral surface. The inner lateral surface may be adapted in particular to the accessory device, in particular a receiving region of the accessory device.

The packaging device may be provided for receiving and retaining the accessory device. The packaging device may enclose the accessory device, in particular entirely. The packaging device may enclose the accessory device by 360° in at least one plane. The packaging device may extend along a longitudinal axis. The packaging device may extend in the circumferential direction about a/the longitudinal axis. The packaging device may retain the accessory device in a force-fitting and/or form-fitting manner along a/the longitudinal axis and/or transversely, in particular perpendicularly, to the longitudinal axis. The packaging device may delimit a movement of the accessory device along a/the longitudinal axis and/or transversely, in particular perpendicularly, to the longitudinal axis.

The accessory device is in particular configured as a drilling tool, a milling tool, a screwing tool, etc. The accessory device is in particular configured to be elongate, preferably along a longitudinal axis. The accessory device is preferably formed from a metal material. The accessory device preferably has a receiving region for the purpose of being received in a machine tool. The receiving region is preferably arranged at a first end of the accessory device. The accessory device preferably has a machining region for machining a workpiece to be machined. The machining region may have a cutting element. The machining region may have a cutting edge. The machining region may have a shaft, in particular a shaft portion. The shaft may be formed or be able to be formed together with the cutting element and/or the cutting edge, in particular integrally. The machining region is preferably arranged at a second end of the accessory device. The second end is preferably arranged on a side of the accessory device facing away from the second end. The accessory device preferably has a connecting region. The connecting region is provided in particular for connecting the receiving region to the machining region. The connecting region is preferably arranged between the receiving region and the machining region. The connecting region is preferably formed so as to be integral with the receiving region and the machining region.

The clamping element may be provided for clamping the accessory device. The clamping element may be provided for retaining the accessory device on the packaging device. The clamping element may clamp the accessory device in a clamping state and/or release the accessory device in a release state. The clamping element may be mounted so as to be movable relative to the accessory device. In a clamping state, the clamping element may be arranged on the accessory device, in particular may contact the accessory device. In a release state, the clamping element may be located at a distance from the accessory device. The clamping element may establish point contact, line contact, and/or plane contact with the accessory device.

The clamping element may enclose the accessory device by 360° in a plane. The clamping element may receive the accessory device. The clamping element may extend, relative to the accessory device, substantially along a radial plane of the accessory device. The radial plane may extend radially to the longitudinal axis of the accessory device. The clamping element may extend radially to the longitudinal axis of the accessory device, in particular in a clamping state. The clamping element may be configured as a clamping extension.

The clamping recess may enclose the accessory device, in particular entirely. The clamping recess may be provided for receiving the accessory device. The clamping recess forms a receiving region for receiving the accessory device. The clamping recess may be configured as an insertion opening, in particular in order to receive the accessory device. The clamping element may be thin. The clamping element may be formed from a metal sheet. The clamping element may, in particular in part, be plate-like. The clamping recess may be configured as an aperture through the material. The clamping recess may extend through the clamping element, in particular through the full extent of the clamping element.

The clamping recess may be delimit by the clamping element. The clamping recess may be formed by the clamping element. The clamping recess may extend in the manner of a circular segment, in particular in a circular manner, around the accessory device. The clamping element may extend in a curved manner around the clamping recess. The clamping recess may be substantially polygonal in a section. The clamping recess may be substantially circular in a section. The clamping recess may be adapted to the accessory device, in particular an outer contour of the accessory device. The clamping recess may be substantially cylindrical.

The clamping element may be movable about an axis, in particular an axis of rotation. The axis of rotation may be arranged substantially parallel to the accessory device, in particular a longitudinal axis of the accessory device. The clamping element may be movable in an angular range about the accessory device, in particular about the longitudinal axis of the accessory device. In a first state (release state), the clamping element may assume a first angle about the accessory device, in particular the longitudinal axis of the accessory device, in particular in order to receive the accessory device. In a second state (clamping state), the clamping element may assume a second angle about the accessory device, in particular the longitudinal axis of the accessory device, this angle enclosing the accessory device in a manner different to the first angle. A movement of the clamping element from the first angle to the second angle may be provided for clamping the accessory device.

It is understood that the longitudinal axis of the accessory device is specified as a reference variable, in particular a geometric reference variable. The longitudinal axis is intended to illustrate a mode of operation of the packaging device. For example, the longitudinal axis of the accessory device may coincide with a clamping axis of the clamping element or the clamping recess. In the present description of the invention, a reference to the longitudinal axis can be considered equivalent to a reference to the clamping axis of the clamping element or the clamping recess.

To receive an accessory device, the packaging device, in particular the clamping element, preferably the clamping recess, may be widened or bent upward. The accessory device can thus be received by the packaging device, in particular the clamping element, preferably the clamping recess or introduced therein. Due to a pretensioning, in particular in a release state and/or a clamping state, the packaging device, in particular the clamping element, preferably the clamping recess, may contract in order to receive and/or retain the accessory device.

It may be expedient for the clamping recess to have a clamping axis. The clamping axis may be arranged substantially perpendicularly to the clamping recess, in particular a recess surface of the clamping recess. The clamping axis of the clamping recess and the longitudinal axis of the accessory device may substantially coincide in a release state and a clamping state. In particular, when arranged in and/or on the clamping recess, the accessory device may be oriented, in particular by the clamping recess, in such a way that the accessory device, in particular the longitudinal axis of the accessory device, coincides with the clamping axis of the clamping recess. The term “coincide” is to be understood to mean that, in at least one state, two axes are arranged so as to be substantially parallel and/or coaxial with each other. The clamping recess may be substantially cylindrical. The clamping recess may extend along a cylinder axis, in particular a cylinder axis forming the clamping axis. The clamping recess may be delimited by the recess surface in the axial direction along the cylinder axis. The recess surface may be substantially circular.

It may further be expedient for the clamping recess to have a diameter which is smaller in a release state than in a clamping state. The clamping recess may have a first diameter, in particular in a release state. The clamping recess may have a second diameter, in particular in a clamping state. The first diameter (release state) of the clamping recess may be larger than the second diameter (clamping state) of the clamping recess. The diameter may be measured relative, in particular perpendicularly, to the clamping axis or to the cylinder axis. In a release state, the clamping recess may widen in such a way that the diameter increases in order to receive the accessory device. In a clamping state, the clamping recess may narrow in such a way that the diameter decreases in order to clamp the accessory device. In a clamping state, the clamping recess may in particular have a diameter adapted to the accessory device, in particular to a diameter of the accessory device. To increase the diameter of the clamping recess, the clamping element may be deformed transversely, in particular perpendicularly, to a clamping axis, in particular bent upward. This makes it possible, in a particularly advantageous manner, to receive the accessory device simply and also to remove the accessory device simply.

Furthermore, it may be expedient for the clamping recess to be arranged on the clamping element and/or to delimit the clamping element. The clamping element may enclose the clamping recess in a plane by at least 120°, in particular by at least 150°, preferably by at least 180°, preferably by at least 210°, more preferably by at least 240°, particularly preferably by at least 270°, and/or by a maximum of 360°, in particular by a maximum of 330°, preferably by a maximum of 300°, preferably by a maximum of 270°, more preferably by a maximum of 240°, particularly preferably by 210°. In this manner, a particularly compact construction of the packaging device may be achieved.

It may be expedient for the clamping element to have a first end, in particular a fixed first end, and a second end, in particular a free second end, remote from the first end. The first end may be retained on the packaging device. The first end may be arranged on a base body. The base body may retain the clamping element on the packaging device or connect the clamping element to the packaging device. The second end may be configured so as to protrude freely. The second end may be mounted so as to be movable in the manner of a spring. The second end may be elastically deflected relative to the first end. The clamping recess may be arranged between the first end and the second end of the clamping element. The clamping recess may be arranged at the first end of the clamping element. A movement, in particular a bending movement, of the second element relative to the first element may alter the clamping recess, in particular increase or decrease the size thereof. The clamping recess may be widened, in particular bent upward, by the movement, in particular the bending movement. This allows the clamping recess to adopt a larger diameter (release state) in order to receive the accessory device. [Describe further AF here] This makes it possible to provide a clamping element in a particularly simple manner.

It may further be expedient for the clamping element to have a chamfer for receiving the accessory device. The chamfer may delimit the clamping element. The chamfer may delimit the clamping recess. The chamfer may form a receiving region, which centers, in particular pre-centers, the accessory device to be received in the clamping recess. This allows the accessory device to be received in a particularly simple manner.

Furthermore, it may be expedient for the clamping element, in particular the clamping recess, to have a clamping surface. The clamping surface may be provided for enclosing the accessory device. The clamping surface may be provided for retaining the accessory device in a force-fitting and/or form-fitting manner. The clamping surface may be curved, in particular about a clamping axis. The curve of the clamping surface may be less pronounced in a clamping state than in a release state. The clamping surface may rest against the accessory device. The clamping surface may cause a clamping force, in particular a radial clamping force, to act on the accessory device. The clamping force may retain the accessory device on the clamping element, in particular in a force-fitting manner. In this way, a particularly simple connection may be achieved.

In addition, it may be expedient for the packaging device to have a spring element for applying a clamping force to the clamping element, wherein the spring element is more highly tensioned in a release state of the clamping element than in a clamping state. The spring element may be formed so as to be integral with the clamping element. The spring element may produce a spring force by elastic deformation of the clamping element. The spring element may produce a greater clamping force in a release state than in a clamping state. The spring element may be configured as a flexible spring element.

A “spring element” is to be understood in particular to mean an element which has at least one extent which, in a normal operating state, is elastically variable by at least 10%, in particular by at least 20%, preferably by at least 30%, and particularly advantageously by at least 50%, and which in particular generates a counterforce which is dependent on a change in the extent, is preferably proportional to the change, and acts counter to the change. An “extent” of an element is to be understood in particular to mean a maximum distance between two points of a perpendicular projection of the element onto a plane.

In addition, it may be expedient for the packaging device to have a further clamping element, which is provided for clamping the accessory device depending on a movement, in particular a rotational movement, of the further clamping element about the accessory device, in particular about a longitudinal axis of the accessory device. The further clamping element may be configured in substantially the same way as the clamping element. The further clamping element may be arranged substantially parallel to the clamping element. The further clamping element may be arranged in a plane parallel to the clamping element. The further clamping element may be arranged so as to be rotated substantially by 180° relative to the clamping element.

It is further proposed that the clamping element overlaps the further clamping element, in particular in a release state and/or in a clamping state.

The further clamping element may have a further clamping recess. The further clamping recess may be configured to be coaxial with the clamping recess. The clamping recess may form a common recess with the further clamping recess.

It is proposed that the clamping element and the further clamping element are formed integrally. The clamping element and the further clamping element may form a clip, in particular a clamping clip. The clip may be substantially annular. The clip may be bent in a tubular manner. The clamping clip may enclose the clamping recess, in particular the clamping axis, by an angle of more than 360°. The clamping clip may extend the clamping recess by at least 360°, in particular by at least 390°, preferably by at least 420°, preferably by at least 460°, further preferably by at least 490°, and/or by a maximum of 630°, in particular by a maximum of 600°, preferably by a maximum of 570°, preferably by a maximum of 540°, further preferably by a maximum of 510°. The clip may be widened to receive the accessory device. The clip may be pretensioned in a clamping state and a release state. The clip may contract due to a pretensioning, in particular by means of a separate or integral spring element, in particular in order to retain the accessory device. The clip may be configured as a spring clip, in particular a spring band clip.

The clamping elements may delimit the packaging device, in particular along the clamping axis. The further clamping elements may delimit the packaging device, in particular along the clamping axis. The clamping elements may overlap, in particular along the clamping axis. The clamping element may be arranged at a first end of the packaging device, in particular along the clamping axis. The further clamping element may be arranged at a second end of the packaging device facing away from the first end, in particular along the clamping axis.

The clamping element and/or the further clamping element may be bent in an annular manner. The clamping element and/or the further clamping element may have end portion extending parallel to each other.

The term “integral” is to be understood in particular to mean at least a materially bonded connection, for example, by a welding process, an adhesive bonding process, an injection molding process and/or another process that appears to the person skilled in the art to be reasonable, and/or advantageously formed in one piece, for example, by production from a casting and/or by production in a single-component or multi-component injection molding process and advantageously from a single blank.

It is proposed that the clamping element has an actuation element for actuating the clamping element from a clamping state to a release state. It is further proposed that the further clamping element has a further actuation element for actuating the further clamping element from a clamping state to a release state. The actuation element may have an actuation surface. The further actuation element may have a further actuation surface. The actuation surfaces may be directed away from each other. The actuation surfaces may be directed away from each other in such a way that the actuation elements, in particular the actuation surfaces, are moved toward each other when the two actuation elements are actuated. The actuation surfaces may be located separated from each other. The actuation surfaces may be located at a greater distance from each other in a clamping state than in a release state.

As a result, the clamping elements may be moved to a release state by a hand, in particular by a thumb and index finger, in order to allow the accessory device to be introduced into the packaging device, for example by the other hand.

As a result, the packaging device can be operated with one hand due to the fact that the two clamping elements held by one hand.

It may be expedient for the packaging device to have a retaining element for retaining the accessory device.

It may be expedient for the clamping element, in particular the clamping recess, to be provided for clamping the accessory device depending on a movement, in particular a rotational movement, of the clamping element relative to the accessory device, in particular a longitudinal axis of the accessory device.

The clamping element may be movable about an axis, in particular an axis of rotation. The axis of rotation may be arranged transversely, in particular perpendicularly, to the accessory device, in particular to a longitudinal axis of the accessory device. The clamping element may be movable in an angular range relative to the accessory device, in particular relative to the longitudinal axis of the accessory device. In a first state (release state), the clamping element may assume a first angle of approximately 90° relative to the accessory device, in particular the longitudinal axis of the accessory device. In a second state (clamping state), the clamping element may assume a second angle, which differs from the first angle, relative to the accessory device, in particular the longitudinal axis of the accessory device. The second angle may assume an angle which differs from approximately 90°. A movement of the clamping element from the first angle to the second angle may be provided for clamping the accessory device.

The clamping element, in particular the clamping recess, may clamp the accessory device by means of a pivoting movement, in particular about the axis of rotation.

The clamping element, in particular the clamping recess, may enclose the accessory device by 360° in a plane. The clamping recess may be substantially circular. The clamping element, in particular the clamping recess, may be adapted to the accessory device, in particular an outer contour of the accessory device. The clamping recess may be substantially cylindrical.

This allows the accessory device to be clamped in a particularly simple and intuitive manner. In particular, the clamping can take place with one hand.

It may further be expedient for the recess axis of the clamping recess and the longitudinal axis of the accessory device to substantially coincide in a release state and/or the recess axis of the clamping recess and the longitudinal axis of the accessory device to be positioned at a transverse angle to each other in a clamping state. In a clamping state, the recess axis of the clamping recess may intersect the longitudinal axis of the accessory device. This allows an accessory device to be retained by means of a relatively small pivoting movement.

It may further be expedient for the retaining element to have a retaining recess. The retaining recess may have a retaining axis. The retaining recess may extend along the retaining axis. The retaining recess may be substantially cylindrical. The retaining recess may be configured as a retaining groove which extends in an elongate manner substantially parallel to an/the axis of rotation of the clamping element. The retaining recess may delimit an insertion region, in particular an insertion depth, of the packaging device.

The retaining recess may have a retaining recess surface. The retaining recess surface may be delimited by the retaining element. The retaining recess surface may delimit an extent of the retaining recess along the retaining axis. The retaining recess surface may be arranged perpendicularly to the retaining axis. The retaining recess may be delimited by a lateral wall. The lateral wall may extend around the retaining axis, in particular in the circumferential direction. The lateral wall may enclose the retaining recess about the retaining axis.

The retaining recess surface may have an extent which is the equal to or greater than an extent of the clamping recess surface. The retaining recess surface may be arranged parallel to the clamping recess surface in a release state and/or arranged transversely or positioned at an angle to the clamping recess surface in a clamping state.

The retaining element may be arranged on and/or connected to a base body element or a housing element.

The clamping recess may have a clamping axis.

In a release state, the retaining axis and the clamping axis may substantially coincide. In a clamping state, the retaining axis and the clamping axis may be positioned at a transverse angle to each other.
Furthermore, it may be expedient for the clamping element, in particular the clamping recess, to be arranged closer to the retaining element in a release state than in a clamping state. The clamping element may move toward the retaining element when moving from the clamping state to the release state. The clamping element may abut the retaining element in a release state. The clamping element may have a stop region. The retaining element may have a stop region. The clamping element may abut the retaining element in a release state as a result of the stop region of the clamping element coming into contact with the stop region of the retaining element. This makes it particularly simple for an operator of the packaging device to identify whether the accessory device can be received in the packaging device.

It is further proposed that the retaining element has a retaining recess, wherein the retaining recess covers, in particular overlaps, the clamping recess to a greater extent in a release state than in a clamping state. In a release state, the retaining recess may be covered substantially entirely by the clamping recess. In a clamping state, the retaining recess may be covered in part by the clamping recess. It is proposed that the accessory device forms a projection plane, in particular a projection plane which extends radially to the retaining axis. In a release state, the projection of the clamping recess along the retaining axis may form a substantially circular shape. In a clamping state, the projection of the clamping recess along the retaining axis may form a shape which differs substantially from a circular shape, in particular may form an elliptical shape.

It is further proposed that the clamping element, in particular the clamping recess, has a clamping edge having a clamping edge portion and/or that the retaining element, in particular the retaining recess, has a retaining edge having a retaining edge portion. The edge portions may each be provided for connecting the accessory device in a force-fitting and/or form-fitting manner. The edge portions are arranged so as to be mutually opposed.

The clamping element may have a clamping edge. The clamping edge may form a clamping contour of the clamping element, in particular the clamping recess. The clamping edge may enclose the clamping recess. The clamping edge may delimit the clamping recess surface. The retaining element may have a retaining edge. The retaining edge may form a retaining contour of the retaining element, in particular the retaining recess. The retaining edge may enclose the retaining recess. The retaining edge may delimit the retaining recess surface. The retaining edge portion may be arranged along the clamping axis on a side of the retaining element facing away from the clamping edge portion. The retaining edge portion may be arranged transversely, in particular perpendicularly, to the retaining axis on a side of the retaining element facing away from the clamping edge portion. The retaining edge portion may be arranged opposite the clamping edge portion. This makes it possible to clamp the accessory device in a particularly simple manner.

Furthermore, it may be expedient for the clamping element and the retaining element to be formed integrally. The clamping element and the retaining element may be bent or folded about an axis of rotation. The clamping element and the retaining element may be connected at the axis of rotation.

In a release state, the clamping recess and the retaining recess may rest against each other in a mutually opposed manner. In a release state, the clamping recess and the retaining recess may be coaxially aligned with each other. As a result, the packaging device may be particularly compact.

Furthermore, it may be expedient for the packaging device to have an actuation element for actuating the clamping element, in particular from a clamping state to a release state. The actuation element may be configured on the clamping element. The actuation element may be arranged at one end of the clamping element. The actuation element may be arranged at an end of the clamping element facing away from the spring element. The actuation element may be provided for receiving the clamping element in a simple manner. The actuation element may have an actuation surface for actuating the actuation element. The actuation surface is arranged on a side of the actuation element facing away from the retaining element. The clamping element may have a clamping surfaces, in particular a clamping surface portion. The actuation surface may be configured at an angle to the clamping surface, in particular to the clamping surface portion. The actuation element allows the accessory device to be received, and in particular adjusted from a clamping state to a release state, in a particularly simple manner. In addition, it is possible, in a particularly advantageous manner, to prevent an operator's finger from becoming trapped.

It may be expedient for the clamping element, in particular the clamping recess, to be provided for clamping the accessory device depending on a translational movement of the clamping element relative to the accessory device, in particular radially to the longitudinal axis of the accessory device.

The clamping element may be mounted so as be translationally movable along an axis of movement. The clamping element may be movable or mounted so as to be movable transversely, in particular perpendicularly, to the accessory device, in particular a longitudinal axis of the accessory device. The clamping element may move the accessory device from a release state to a clamping state by means of a sliding movement. The axis of movement may be arranged transversely, in particular perpendicularly, to the accessory device, in particular a longitudinal axis of the accessory device. The clamping element, in particular the clamping recess, may be mounted so as to be movable relative to the retaining element, in particular a retaining recess of the retaining element. In a release state, the clamping element, in particular the clamping recess, may cover, in particular entirely cover, the retaining element, in particular a retaining recess of the retaining element, in particular in a substantially concentric manner. In a clamping state, the clamping element, in particular the clamping recess, may be offset, in particular located at a distance, from the retaining element, in particular from a retaining recess of the retaining element.

It may further be expedient for the clamping recess to have a clamping axis which is arranged substantially perpendicularly to the clamping recess, in particular to a recess surface of the clamping recess. In a release state, the clamping axis of the clamping recess and the longitudinal axis of the accessory device may coincide. In a clamping state, the clamping axis of the clamping recess and the longitudinal axis of the accessory device may be located at a distance from each other. The clamping axis of the clamping recess and the longitudinal axis of the accessory device may be parallel to each other in the release state and in the clamping state. This makes it possible to achieve a particularly compact packaging device.

It may further be expedient for the clamping element, in particular the clamping recess, to be arranged parallel to the retaining element in a clamping state and/or in a release state. This makes it possible to achieve a particularly thin design of the clamping element and of the retaining element.

In addition, it may be expedient for the clamping element, in particular the clamping recess, to have a clamping surface/clamping contour, which is provided for enclosing the accessory device and retaining the latter in a force-fitting and/or form-fitting manner.

### BRIEF DESCRIPTION OF THE DRAWINGS

Further advantages emerge from the description of the drawings hereinafter. Exemplary embodiments of the invention are shown in the drawings. The drawings, the description, and the claims contain numerous features in combination. A person skilled in the art will appropriately also consider the features individually and combine them to form further meaningful combinations. The drawings show:

FIG. 1 a perspective view of a packaging device according to the invention,

FIG. 2 four perspective views of the packaging device from FIG. 1,

FIG. 3 two enlarged views of the packaging device from FIG. 1,

FIG. 4 a perspective view of a development of the packaging device from FIG. 1,

FIG. 5 an enlarged perspective view of the packaging device from FIG. 4,

FIG. 6 two schematic plan views of the packaging device according to FIG. 4,

FIG. 7 two schematic sectional views of the packaging device according to FIG. 4,

FIG. 8 a perspective view of a development of the packaging device from FIG. 4,

FIGS. 9, 10 different views of parts of the packaging device according to FIG. 8,

FIG. 11 two schematic plan views of a development of the packaging device in FIG. 4, and

FIG. 12 two schematic sectional views of the packaging device according to FIG. 4.

In the following figures, like components are provided with like reference signs.

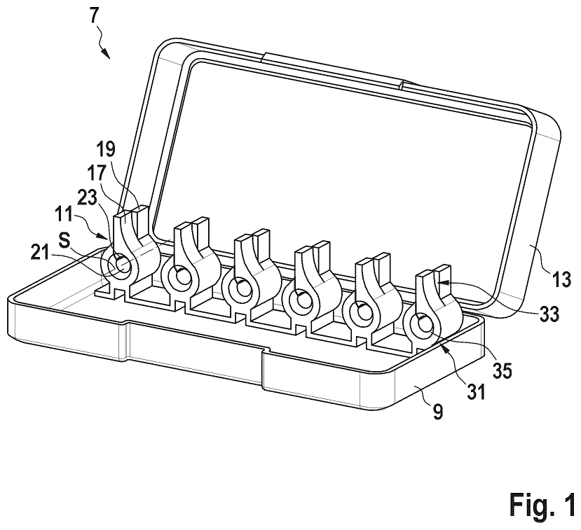

FIG. 1 shows a packaging box 7 having a base body unit 9, having a plurality of, in particular six, packaging devices 11 received by the base body unit 9, and having a lid element 13, which is arranged so as to be movably mounted on the base body unit 9 in order to be able to close it. The packaging box 7 is preferably provided for receiving a, in particular a plurality of accessory devices 15, for example drilling tools, milling tools, etc.

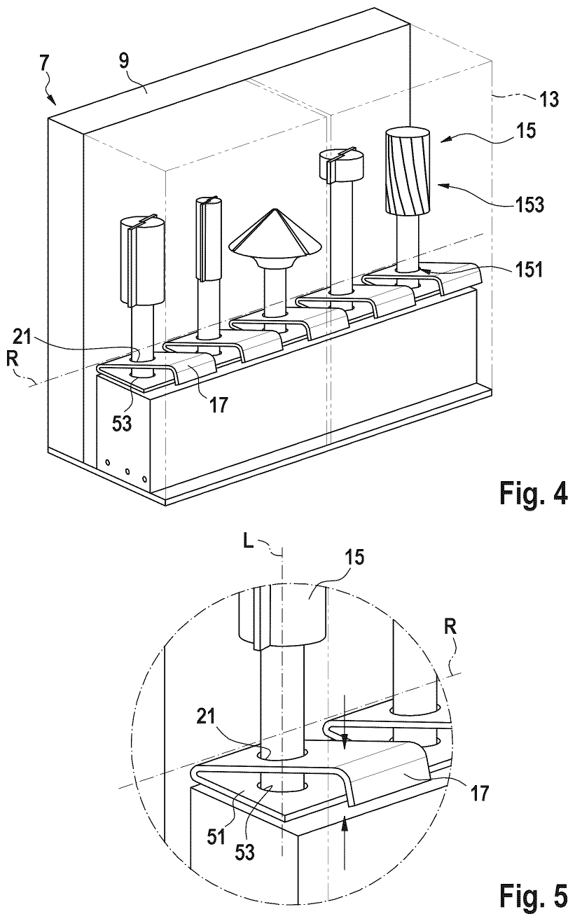

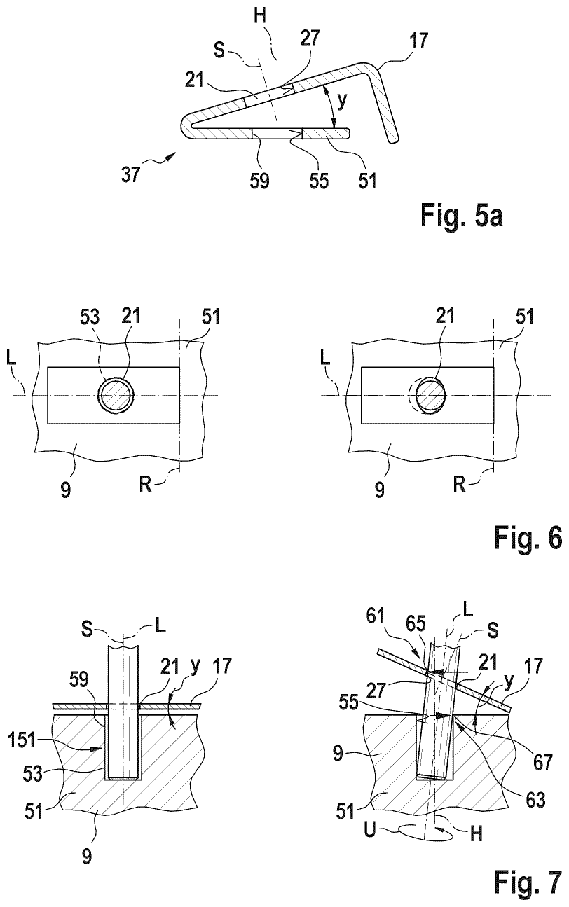

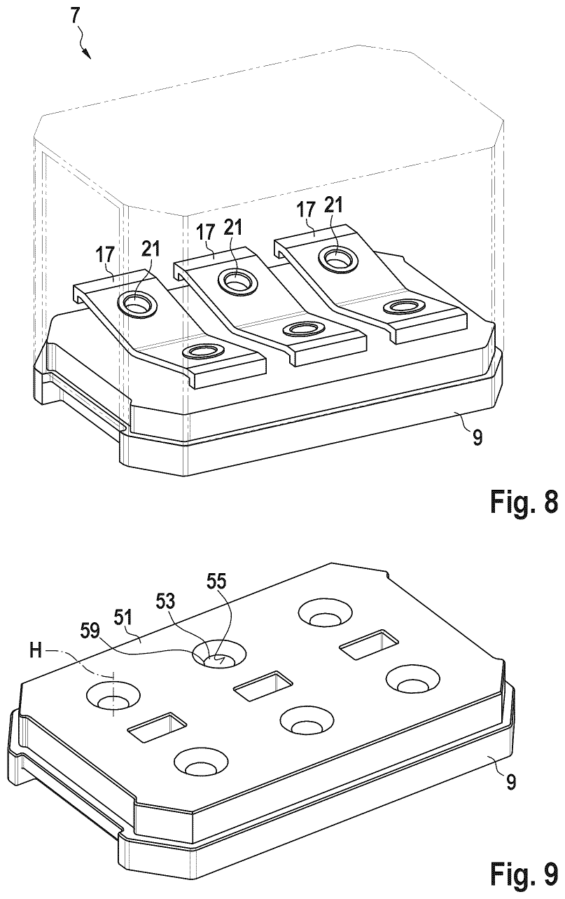

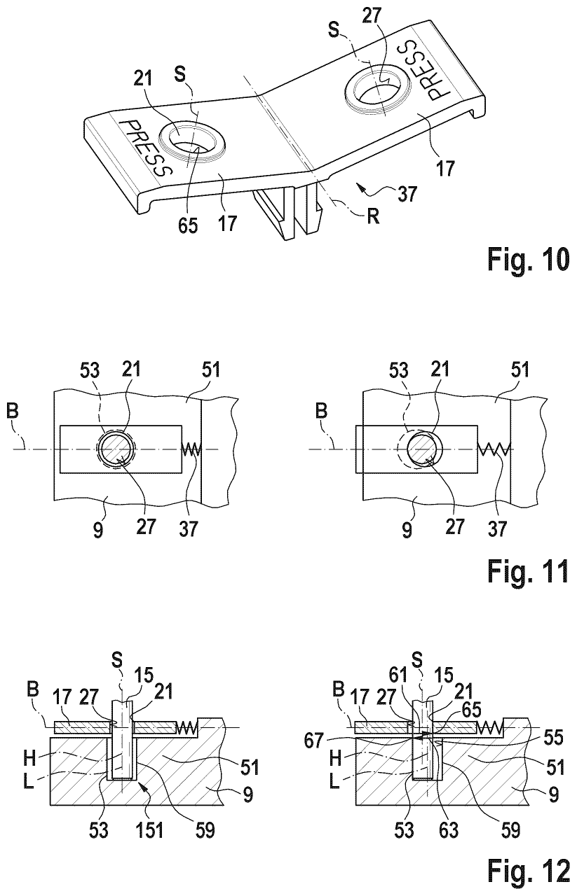

The packaging device 11 is configured with a clamping element 17 for clamping the accessory device 15 and with a clamping recess 21 configured in the clamping element 17 for receiving the accessory device 15. The clamping recess 21 is provided for clamping the accessory device 15 depending on a rotational movement (FIGS. 1 to 3), a rotational and translational movement (FIGS. 4 to 10), and a translational movement (FIGS. 11 to 12) of the clamping element 17 about or relative to a longitudinal axis L of the accessory device 15.

In FIG. 1, the clamping element 17 clamps the accessory device 15 by means of a rotational movement of the clamping element 17 or the clamping recess 21, 23 in the circumferential direction U about the longitudinal axis L of the accessory device 15 and/or unclamps the accessory device 15 by means of a corresponding opposite movement counter to the circumferential direction U. The clamping element 17 or clamping recess 21 is provided to widen in order to receive the accessory device 15, and to narrow in order to clamp the accessory device 15.

The clamping element 17 has a clamping surface 23. The clamping surface 23 forms an inner clamping surface of the clamping recess 21. The clamping surface 23 delimits the clamping element 17 and the clamping recess 21. The clamping element 17 is provided for clamping the accessory device 15 by means of the clamping surface 23. The clamping surface 23 is adapted to a receiving region 151 of the accessory device 15.

The packaging device 11 is provided for receiving and retaining the accessory device 15. The packaging device 11 encloses the accessory device 15 by 360° in at least one plane. The packaging device 11 extends along the longitudinal axis L and in the circumferential direction U about the longitudinal axis L. The packaging device 11 retains the accessory device 15 in a force-fitting manner along the longitudinal axis L and perpendicularly to the longitudinal axis L of the packaging device 11. The packaging device 11 delimits a movement of the accessory device 15 along the longitudinal axis L and perpendicularly to the longitudinal axis L.

The accessory device 15 is configured as a drilling tool, a milling tool, a screwing tool, etc. The accessory device 15 is in particular elongate, preferably along the longitudinal axis L. The accessory device 15 is preferably formed from a metal material. The accessory device 15 preferably has a receiving region 151 for being received in a machine tool. The receiving region 151 is preferably arranged at a first end of the accessory device 15. The accessory device 15 preferably has a machining region 153 for machining a workpiece to be machined. The machining region 153 has a cutting element having a cutting edge (not shown in greater detail) have. The machining region 153 has a shaft having a shaft portion. The shaft may be formed or be able to be formed so as to be integral with the cutting element and/or the cutting edge. The machining region 153 is arranged at a second end of the accessory device 15. The second end is arranged on a side of the accessory device 15 facing away from the second end. The accessory device 15 preferably has a connecting region. The connecting region 155 is provided for connecting the receiving region 151 to the machining region 153. The connecting region 155 is preferably arranged between the receiving region 151 and the machining region 153. The connecting region 155 is preferably formed so as to be integral with the receiving region 151 and the machining region 153.

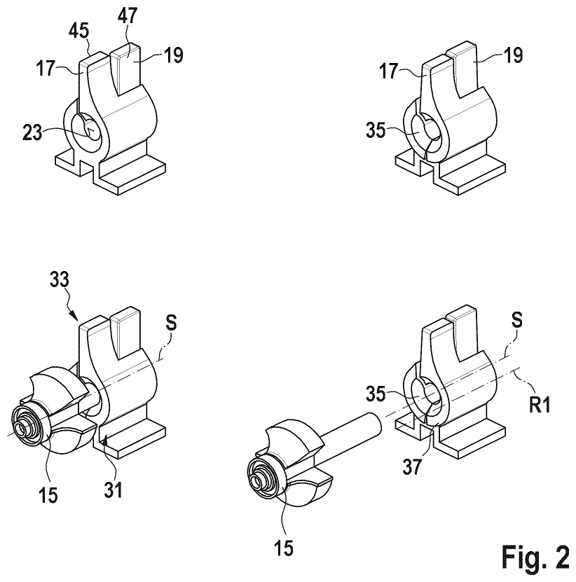

The clamping element 17, 19 is provided for clamping the accessory device 15, in order to retain the accessory device 15 on the packaging device 11. For this purpose, the clamping element 17, 19 may clamp the accessory device 15 in a clamping state (FIGS. 2, 3, 6, 7, 11, 12; right) and release the latter in a release state (FIGS. 2, 3, 6, 7, 11, 12; left). The clamping element 17, 19 is mounted so as to be movable relative to the accessory device 15 and is arranged on the accessory device 15 in a clamping state. In the clamping state, the clamping element 17, 19 contacts the accessory device 15. In a release state, the clamping element 17, 19 is located at a distance from the accessory device 15. The clamping element 17, 19 establishes line contact (FIG. 7; right) and/or plane contact (FIGS. 1 to 3 and 11 to 12) with the accessory device 15.

The clamping element 17, 19 encloses the accessory device 15 by 360° in a plane in order to receive the accessory device 15. The clamping element 17, 19 extends relative to the accessory device 15 substantially along a radial plane of the accessory device 15. The radial plane is spanned radially to the longitudinal axis L of the accessory device 15. In a clamping state, the clamping element 17, 19 extends radially to the longitudinal axis L of the accessory device 15. The clamping element 17, 19 is configured as a clamping extension (FIGS. 1 to 3).

The clamping element 17, 19 is configured so as to be movable about an axis R1 of rotation and is arranged substantially parallel to a longitudinal axis L of the accessory device 15 (FIGS. 1 to 3). The clamping element 17, 19 is movable, in particular elastically deformable, in an angular range about the longitudinal axis L of the accessory device 15. In a release state, the clamping element 17, 19, assumes a first angle x1 about the longitudinal axis L of the accessory device 15 in order to receive the accessory device 15 in the clamping recess 21, 23. In a clamping state, the clamping element 17, 19 assumes a second angle x2 about the longitudinal axis L of the accessory device 15, this second angle being smaller than the first angle x1 and enclosing the accessory device 15 to a greater extent. In a clamping state, the clamping element 17, 19 extends further around the accessory device 15 in the circumferential direction U than in a release state. The second angle x2 encloses the accessory device 15 to a greater extent than the first angle x1. A movement of the clamping element 17, 19 from the first angle x1 to the second angle x2 is provided for clamping the accessory device 15.

The clamping recess 21, 23 encloses the accessory device 15 entirely and is provided for receiving the accessory device 15. The clamping recess 21, 23 forms a receiving region 151 for receiving the accessory device 15. The clamping recess 21, 23 is configured as an insertion opening in order to receive the accessory device 15 in the insertion opening (FIGS. 1 to x). The clamping element 17, 19 is formed from a metal sheet (FIGS. 4 to 12). The clamping element 17, 19 is, in part, plate-like. The clamping recess 21, 23 is configured as an aperture through the material. The clamping recess 21, 23 extends through the full extent of the clamping element 17, 19.

The clamping recess 21, 23 is delimit by the clamping element 17, 19 and formed by the clamping element 17, 19. The clamping recess 21, 23 extends in the manner of a circular segment (FIGS. 1 to 3) or in a circular manner (FIGS. 4 to 12) around the accessory device 15. The clamping element 17, 19 extends in a curved manner around the clamping recess 21, 23. The clamping recess 21, 23 is substantially circular in a section (FIGS. 4 to 12). The clamping recess 21, 23 is adapted to an outer contour of the receiving region 151 of the accessory device 15 and is substantially cylindrical. The clamping recess 21, 23 has a clamping axis S, which extends substantially along a cylinder axis of the clamping recess 21, 23. The clamping axis S passes through the clamping element 17, 19 along the clamping recess 21, 23. The clamping axis S is substantially enclosed by the clamping recess 21, 23. The clamping axis S of the clamping recess 21, 23 and the longitudinal axis L of the accessory device 15 substantially coincide in a release state and in a clamping state. When arranged in and/or on the clamping recess 21, 23, the accessory device 15 is oriented by the clamping recess 21, 23 in such a way that the longitudinal axis L of the accessory device 15 coincides with the clamping axis S of the clamping recess 21, 23. The longitudinal axis L and the clamping axis S are oriented so as to be substantially parallel and substantially coaxial with each other. The clamping recess 21, 23 extends along a cylinder axis forming the clamping axis S.

The clamping recess 21, 23 has a recess surface 27, in particular a notional recess surface 27. The clamping recess 21, 23 is delimited in the axial direction along the cylinder axis by the recess surface 27. The recess surface 27 is substantially circular.

In a release state, the clamping recess 21, 23 has a first diameter D1. In a clamping state, the clamping recess 21, 23 has a second diameter D2. The first diameter D1 is greater in the release state of the clamping recess 21, 23 than the second diameter D2 in the clamping state. The diameter D1, D2 is measured perpendicularly to the clamping axis S or the cylinder axis or the longitudinal axis L. In a release state, the clamping recess 21, 23 widens in such a way that the diameter D1 increases in order to receive the accessory device 15. In a clamping state, the clamping recess 21, 23 narrows in such a way that the diameter D2 decreases in order to clamp the accessory device 15. In a clamping state, the clamping recess 21, 23 has a diameter D2, which is adapted to a diameter of the receiving region 151 of the accessory device 15.

The clamping recess 21, 23 is arranged on the clamping element 17, 19 and delimits the clamping element 17, 19. The clamping element 17, 19 encloses the clamping recess 21, 23 in a plane by an angle x1, x2 of at least 210° and by a maximum of 270°.

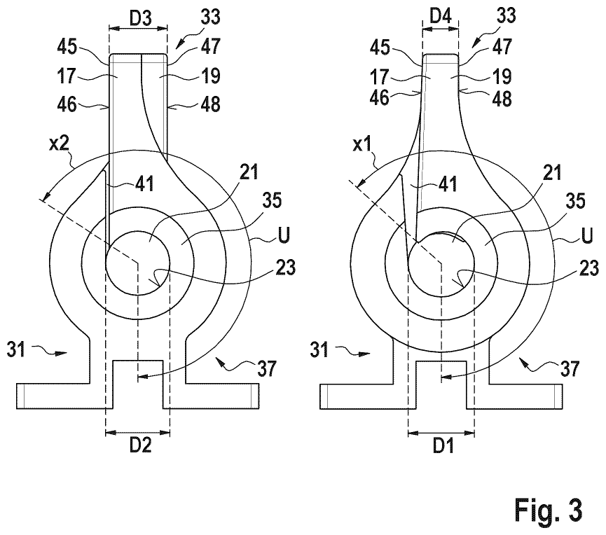

The clamping element 17, 19 has a fixed first end 31 and a free second end 33 facing away from the first end 31. The first end 31 is retained on the packaging device 11 and is arranged on the base body unit 9. The base body unit 9 retains or connects the clamping element 17, 19 on or to the packaging device 11. The second end 33 is configured so as to protrude freely and is mounted so as to be movable in the manner of a spring. The second end 31 is elastically deflectable relative to the first end 31. The clamping recess 21, 23 is arranged between the first end 31 and the second end 33 of the clamping element 17, 19. The clamping recess 21, 23 is arranged at the first end 31 of the clamping element 17, 19. A bending movement of the second end 33 relative to the first end 31 alters the clamping recess 21, 23, in particular increases or decreases the size thereof. The bending movement causes the clamping recess 21, 23 to bend open in order to widen the clamping recess 21, 23, cf. FIG. 3 left and right.

The clamping element 17, 19 has a chamfer 35 for receiving the accessory device 15, which delimits the clamping element 17, 19. The chamfer 35 delimits the clamping recess 21, 23 and forms a receiving region 151 for receiving and centering the accessory device 15 in the clamping recess 21, 23.

The clamping recess 21, 23 has a clamping surface 23, which is provided for enclosing the accessory device 15 and retaining the latter in a force-fitting and/or form-fitting manner. The clamping surface 23 is configured so as to curve around the clamping axis S. The curve of the clamping surface 23 is less pronounced in a clamping state than in a release state. The clamping surface 23 rests against the accessory device 15 and causes a radial clamping force to act on the accessory device 15. The clamping force retains the accessory device 15 on the clamping element 17, 19 in a force-fitting manner.

The packaging device 11 has a spring element 37 for applying a clamping force to the clamping element 17, 19. The spring element 37 is more highly tensioned in a release state of the clamping element 17, 19 than in a clamping state. The spring element 37 is formed so as to be integral with the clamping element 17, 19. The spring element 37 is formed as a result of the inherent properties of the clamping element 17, 19. The spring element 37 produces a spring force by elastic deformation of the clamping element 17, 19. The spring element 37 produces a greater clamping force in the release state than in a clamping state. The spring element 37 forms a flexible spring element 37 and extends from the first end 31 of the clamping element 17, 19 to the second end 33 facing away from the first end 31. The spring element 37 extends from the first end 31 to between the first end 31 and the second end 33 of the clamping element 17, 19.

The spring element 37 may be configured as a separate spring element, which is connectable to the clamping element (FIGS. 11 to 12). In this case, the spring element is configured as a spiral spring. The spring element is configured as a tension spring.

The packaging device 11 has a further clamping element 19, which is provided for clamping the accessory device 15 depending on a rotational movement of the further clamping element 19 about a longitudinal axis L of the accessory device 15. The further clamping element 19 is configured in substantially the same way as the clamping element 17. The further clamping element 19 is arranged in a plane parallel to the clamping element 17. The further clamping element 19 is arranged so as to be rotated substantially by 180° relative to the clamping element 17. The clamping element 17 and the further clamping element 19 overlap in a release state and in a clamping state (FIGS. 1 to 3).

The clamping element 17 may transition into the further clamping element 19. The two clamping elements 17, 19 together form a clamping clip (FIGS. 1 to 3). In a clamping state, the clamping clip encloses the clamping recess 21, 23 or the clamping axis S by an angle of at least 360°, and in particular by at least 450°, up to a maximum of 540°, for example between an angle of 490° and 510°. The clamping clip widens in order to receive the accessory device 15. The clamping clip is pretensioned in a clamping state and in a release state. The clamping clip contracts due to a pretensioning by means of an integral spring element 37 in order to retain the accessory device 15. The clamping clip is configured as a spring clip or a spring band clip. In comparison with a clamping state, the clamping clip widens in a release state in a plane by an angle of more than 10°, in particular more than 20°, and in particular less than 40°, in order to receive the accessory device 15. The clamping clip has a clamping gap 41. The clamping gap 41 is configured to be larger in a release state than in a clamping state.

The further clamping element 19 has a further clamping recess 23. The further clamping recess 23 is configured so as to be coaxial with the clamping recess 21. The clamping recess 21 forms a common recess with the further clamping recess 23, this common recess being enclosed by the clamping clip.

The clamping element 17 is formed so as to be integral with the further clamping element 19.

The clamping element 17 has an actuation element 45 for actuating the clamping element 17 from a clamping state to a release state, and the further clamping element 19 has a further actuation element 47 for actuating the further clamping element 19 from a clamping state to a release state, wherein the actuation element 45 has an actuation surface 46 and the further actuation element 45, 47 has a further actuation surface 48, wherein the actuation surfaces 46, 48 are directed away from each other. The actuation surfaces 46, 48 are directed away from each other in such a way that the actuation surfaces 46, 48 are moved toward each other when the two actuation elements 45, 47 are actuated. The actuation surfaces 46, 48 are located at a distance from each other in a release state and a clamping state. The actuation surfaces 46, 48 are located at a greater distance from each other in a clamping state than in a release state. The actuation surfaces 46, 48 are positioned at an angle, in particular a slight angle, to each other in the circumferential direction U about the clamping axis S at least in one state. The actuation surfaces 46, 48 are located at a distance D3 from each other in a clamping state. The actuation surfaces 46, 48 are located at a distance D4 from each other in a release state. The distance D4 is greater than the distance D3, cf. FIG. 3.

The clamping element 17 is provided for clamping, by means of the clamping recess 21, the accessory device 15 depending on a rotational movement of the clamping element 17 relative to the longitudinal axis L of the accessory device 15 (FIGS. 4 to 10). The clamping element 17 is movably deflectable about an axis R of rotation. The axis R of rotation is arranged perpendicularly to the longitudinal axis L of the accessory device 15. The clamping element 17 is movable in an angular range y relative to the longitudinal axis L of the accessory device 15. In a release state, the clamping element 17 assumes a first angle y of approximately 90° relative to the longitudinal axis L of the accessory device 15. In a clamping state, the clamping element 17 assumes a second angle y, which differs from the first angle y and differs from approximately 90°, relative to the longitudinal axis L of the accessory device 15. A movement of the clamping element 17 from the first angle y to the second angle y is provided for clamping the accessory device 15.

The clamping element 17 or clamping recess 21 clamps the accessory device 15 by means of a pivoting movement about the axis R of rotation.

The clamping element 17 or the clamping recess 21 encloses the accessory device 15 by 360° in a plane and is substantially circular in this plane. The clamping recess 21 is adapted to an outer contour of the accessory device 15.

The clamping axis S of the clamping recess 21 and the longitudinal axis L of the accessory device 15 substantially coincide in a release state and are arranged transversely to each other in a clamping state. The clamping axis S of the clamping recess 21 intersect the longitudinal axis L of the accessory device 15 in a clamping state.

The packaging device 11 has a retaining element 51 for retaining the accessory device 15. The retaining element 51 has a retaining recess 53. The retaining recess 53 has a retaining axis H. The retaining recess 53 extends along the retaining axis H. The retaining recess 53 is substantially cylindrical. The retaining recess 53 is configured as a blind hole. The retaining recess 53 delimits an insertion depth of the packaging device 11.

The retaining recess 53 has a retaining recess surface 55, which is delimited by the retaining element 51. The retaining recess surface 55 delimits an extent of the retaining recess 53 along the retaining axis H. The retaining recess surface 55 is arranged perpendicularly to the retaining axis H. The retaining recess 53 is delimited by a lateral wall 59, which extends in the circumferential direction U around the retaining axis H and encloses the latter.

The retaining recess surface 55 has an extent, which corresponds approximately to an extent of the clamping recess surface 27. The retaining recess surface 55 is arranged parallel to the clamping recess surface 27 in a release state, and is arranged transversely or positioned at an angle thereto in a clamping state.

The retaining axis H and the clamping axis S substantially coincide in a release state. The retaining axis H and the clamping axis S are positioned at a transverse angle to each other in a clamping state (FIG. 7). The retaining axis H and the clamping axis S are positioned at an angle to the longitudinal axis L of the accessory device. It is understood that designing, for example, a diameter of the retaining recess to more closely match the diameter of the accessory device results in less clearance in the retaining recess, thus allowing the retaining axis H to be arranged approximately parallel to the longitudinal axis L of the accessory device in both the clamping state and the release state.

The clamping element 17, in particular the clamping recess 21, is arranged closer to the retaining element 51, in particular the retaining recess 53, in a release state than in a clamping state. When moving from the clamping state to the release state, the clamping element 17 moves toward the retaining element 51. In a release state, the clamping element 17 abuts the retaining element 51. The clamping element 17 has a stop region 61. The retaining element 51 has a stop region 63. The clamping element 17 reaches a release state as a result of the stop region 61 of the clamping element 17 contacting or being arranged on the stop region 63 of the retaining element 51. The stop region 61 of the clamping recess 21 and the stop region 63 of the retaining recess 53 are arranged so as to be mutually opposed in a release state. The clamping recess 21 and the retaining recess 53 are coaxially aligned with each other in a release state.

The retaining recess 53 covers or overlaps the clamping recess 21, 23 to a greater extent in a release state than in a clamping state. In a release state, the retaining recess 53 is covered substantially entirely by the clamping recess 21. In a clamping state, the retaining recess 53 is covered in part by the clamping recess 21. The accessory device 15 forms a projection plane extending radially to the retaining axis H. The projection of the clamping recess 21 along the retaining axis H forms a substantially circular shape in a release state and a substantially elliptical shape in a clamping state (FIG. 11).

The clamping element 17 has a clamping edge 65. The clamping edge 65 forms a clamping contour of the clamping element 17, in particular the clamping recess 21. The clamping edge 65 is substantially round. The clamping edge 65 encloses the clamping recess 21. The clamping edge 65 delimits the clamping recess surface 27. The clamping edge 65 has a first clamping edge portion for connecting the accessory device 15 in a force-fitting and/or form-fitting manner.

The retaining element 51 has a retaining edge 67. The retaining edge 67 forms a retaining contour of the retaining element 51, in particular the retaining recess 53. The retaining edge 67 is substantially round. The retaining edge 67 encloses the retaining recess 53. The retaining edge 67 delimits the retaining recess surface 55. The retaining edge 67 has a retaining edge portion for connecting the accessory device 15 in a force-fitting and/or form-fitting manner.

The retaining edge portion is arranged along the clamping axis S on a side of the retaining element 51 facing away from the retaining edge portion. The retaining edge portion is arranged transversely, in particular perpendicularly, to the retaining axis H on a side of the retaining element 51 facing away from the clamping edge portion. The retaining edge portion is arranged opposite the clamping edge portion. The edge portions (clamping edge portion, retaining edge portion) are arranged opposite the clamping axis S or the retaining axis H on two sides facing away from each other. The edge portions extend concentrically around the clamping axis S or the retaining axis H.

The clamping element 17 and the retaining element 51 are formed integrally and are bent or folded about an axis R of rotation. The clamping element 17 and the retaining element 51 are connected to the axis R of rotation and are connected so as to be movable about the latter.

FIG. 4 et seq. show an actuation element 45 for actuating the clamping element 17 from a clamping state to a release state. The actuation element 45 is configured on the clamping element 17. The actuation element 45 is arranged at one end of the clamping element 17. The actuation element 45 is arranged at an end of the clamping element 17 facing away from the spring element 37. The actuation element 45 is provided for receiving the clamping element 17 in a simple manner. The actuation element 45 has an actuation surface for actuating the actuation element 45. The actuation surface is arranged on a side of the actuation element 45 facing away from the retaining element 51. The actuation surface is configured at an angle to the clamping surface 23, in particular the clamping surface portion.

The clamping element 17 or clamping recess 21 is provided for clamping the accessory device 15 depending on a translational movement of the clamping element 17, 19 relative to the accessory device 15 and radially to the longitudinal axis L of the accessory device 15 or to the retaining axis H of the retaining recess or to the clamping axis S of the clamping recess.

The retaining element 51 is arranged on and connected to the base body unit 9.

FIGS. 11 and 12 show a development of the invention. In this case, the clamping element 17 or clamping recess 21 is mounted so as to be translationally movable along an axis B of movement. The clamping element 17 is movably mounted so as to be substantially perpendicular to the longitudinal axis L of the accessory device 15. The clamping element 17 moves the accessory device 15 from a release state to a clamping state by means of a sliding movement. The axis of movement is arranged substantially perpendicularly to the longitudinal axis L of the accessory device 15. The clamping element 17 or the clamping recess 21 is mounted so as to be movable relative to the retaining element 51 or the retaining recess 53. In a release state, the clamping recess 21 of the clamping element 17 covers the retaining recess 53 of the retaining element 51 substantially entirely. In a release state, the clamping axis S of the clamping recess 21 coincides with the retaining axis H of the retaining recess 53. In a release state, the clamping axis S is arranged so as to be coaxial with the retaining axis H. In a release state, the clamping recess 21 is arranged or configured so as to be concentric with the retaining recess 53. In a clamping state, the clamping axis S is arranged at a distance from the retaining axis H. The clamping axis S is arranged so as to be parallel to the release axis in a clamping state and in a release state. In a clamping state, the clamping recess 21 of the clamping element 17 is arranged so as to be offset, in particular located at a distance, from the retaining recess 53 of the retaining element 51.

The clamping axis S of the clamping recess 21 is arranged substantially perpendicularly to the recess surface 27 of the clamping recess 21. In a release state, the clamping axis S of the clamping recess 21 and the longitudinal axis L of the accessory device 15 coincide. In a clamping state, the clamping axis S of the clamping recess 21 and the longitudinal axis L of the accessory device 15 are located at a distance from each other due to the fact that the accessory device 15 is pushed to one side of the clamping element 17 in the clamping recess 21. The clamping axis S of the clamping recess 21 and the longitudinal axis L of the accessory device 15 are arranged so as to be parallel to each other in the release state and in the clamping state.

The clamping element 17 has a clamping edge 65, which forms a clamping contour of the clamping element 17 and is provided for enclosing the accessory device 15 and retaining the latter in a force-fitting and/or form-fitting manner. The clamping contour causes the accessory device 15 to be clamped against the retaining recess 53. In the clamping state, the accessory device 15 is clamped between the clamping contour of the clamping element 17 and a further clamping contour of the retaining element 51. The clamping element 17 is configured in a manner similar to the development according to FIGS. 4 to 10.

The clamping element 17 further comprises an actuation element 45, which is arranged on an end face of the clamping element 17. The actuation element 45 is provided on a side of the clamping element 17 facing away from the spring element 37. The actuation element 45 is provided for actuating the clamping element 17 in order to actuate the latter from a clamping state to a release state. The spring element 37 is biased, and is in particular pretensioned to a greater extent in the release state than in the clamping state.

1. A packaging device for an accessory device, having a retaining element for retaining the accessory device, having a clamping element for clamping the accessory device, and having a clamping recess for receiving the accessory device, wherein the clamping recess is configured to clamp the accessory device depending on a movement of the clamping element relative to a longitudinal axis of the accessory device.

2. The packaging device according to claim 1, wherein the clamping recess has a clamping axis which is arranged substantially perpendicularly to a recess surface of the clamping recess, and wherein the clamping axis of the clamping recess and the longitudinal axis of the accessory device substantially coincide in a release state and/or the clamping axis of the clamping recess and the longitudinal axis of the accessory device are positioned at a transverse angle to each other in a clamping state.

3. The packaging device according to claim 1, wherein the retaining element has a retaining recess having a retaining axis, wherein the clamping recess has a clamping axis, and wherein the retaining axis and the clamping axis substantially coincide in a release state and/or the retaining axis and the clamping axis are positioned at a transverse angle to each other in a clamping state.

4. The packaging device according to claim 1, wherein the clamping recess is arranged closer to the retaining element in a release state than in a clamping state.

5. The packaging device according to claim 1, wherein the retaining element has a retaining recess, and wherein the retaining recess covers the clamping recess to a greater extent in a release state than in a clamping state.

6. The packaging device according to claim 1, wherein the clamping element has a fixed end and a free end facing away from the fixed end.

7. (canceled)

8. The packaging device according to claim 1, wherein the clamping recess has a clamping edge having a clamping edge portion, and the retaining recess, has a retaining edge having a retaining edge portion, wherein the edge portions are each provided for connecting the accessory device in a force-fitting and/or form-fitting manner, and wherein the edge portions are arranged so as to be mutually opposed.

9. The packaging device according to claim 1, further comprising a spring element configured to apply a clamping force to the clamping element, and wherein the spring element is tensioned to a greater extent in a release state of the clamping element than in a clamping state.

10. The packaging device according to claim 9, wherein the spring element and the clamping element are formed integrally.

11. The packaging device according to claim 1, wherein the clamping element and the retaining element are formed integrally.

12. The packaging device according to claim 1, further comprising an actuation element configured to actuate the clamping element from a clamping state to a release state.

13. The packaging device according to claim 1, wherein the clamping recess is configured to clamp the accessory device depending on a rotational movement of the clamping element relative to the accessory device.
